(19) United States
(12) Patent Application Publication
(10) Pub. No.: US 2014/0176816 A1
(43) Pub. Date: Jun. 26, 2014

(54) ILLUMINATION DEVICE, DISPLAY DEVICE USING SAME, AND TELEVISION RECEIVING DEVICE

(71) Applicant: Nobuhiro Kasai, Osaka-shi (JP)

(72) Inventor: Nobuhiro Kasai, Osaka-shi (JP)

(73) Assignee: SHARP KABUSHIKI KAISHA, Osaka-shi, Osaka (JP)

(21) Appl. No.: 14/240,469

(22) PCT Filed: Aug. 30, 2012
(86) PCT No.: PCT/JP2012/071944

§ 371 Date: Feb. 24, 2014

(30) Foreign Application Priority Data
Sep. 5, 2011 (JP) 2011-193203

(51) Int. Cl. F21V 8/00; F21K 99/00

(52) U.S. Cl. CPC G02B 6/0011; F21K 9/52
USPC 348/790; 362/611; 362/612; 349/65

(57) ABSTRACT

This illumination device is provided with light sources (15) arranged in one direction along a line or side-by-side, a light-guide plate (14) which guides light incident from an incidence surface (14a) on the side circumferential surface across from the light sources (15) and emits planar illumination light from an exit surface (14b) on the front surface, a chassis (13) which covers and supports the light sources (15) and the periphery of the light-guide plate (14), a scattering pattern (18) which is formed on the back surface (14c) of the light-guide plate (14), and positioning units (14g) which are provided jutting from the side peripheral surface of the light-guide plate (14) for positioning the light-guide plate (14) by fitting with the inner surface of the chassis (13), wherein the scattering pattern (18) is provided so as to extend on the positioning units (14g).

### TECHNICAL FIELD

The present invention relates to an illumination device including a light guide plate, a display device using the same, and a television receiving device.

### BACKGROUND ART

Patent Document 1 discloses a conventional illumination device. This illumination device constitutes a backlight of a display device and has a light guide plate and light sources that are held in a chassis thereof. The light sources are composed of a plurality of LEDs and are provided side by side in one direction on a substrate. The light guide plate is formed in the shape of a thin plate rectangular in planar view and has, at one side circumferential surface thereof, an incidence surface opposed to the light sources. At a front surface of the light guide plate, an emission surface for emitting illumination light is formed. Furthermore, a reflection sheet is arranged on the side circumferential surface of the light guide plate in intimate contact therewith so as to avoid the light sources.

Emission light emitted by the light sources enters the light guide plate from the incidence surface and is guided through the light guide plate. Light that has been guided through the light guide plate and entered the emission surface at an incidence angle smaller than a critical angle is emitted as illumination light from the emission surface. Furthermore, light that has reached the side circumferential surface of the light guide plate is reflected by the reflection sheet to be guided again through the light guide plate and then is emitted from the emission surface.

Furthermore, Patent Document 2 discloses an illumination device including a light guide plate provided on its back surface with a scattering pattern. The scattering pattern is formed in the form of dots, and a multitude of such dots are formed so as to be dispersed on the back surface of the light guide plate. By the scattering pattern, light that has been guided through the light guide plate is reflected in a scattered manner at the back surface of the light guide plate in a direction toward an emission surface thereof. With this configuration, uniform illumination light is emitted from the emission surface, and light that reaches a side circumferential surface of the light guide plate is decreased, as a result of which the need for a reflection sheet can be eliminated.

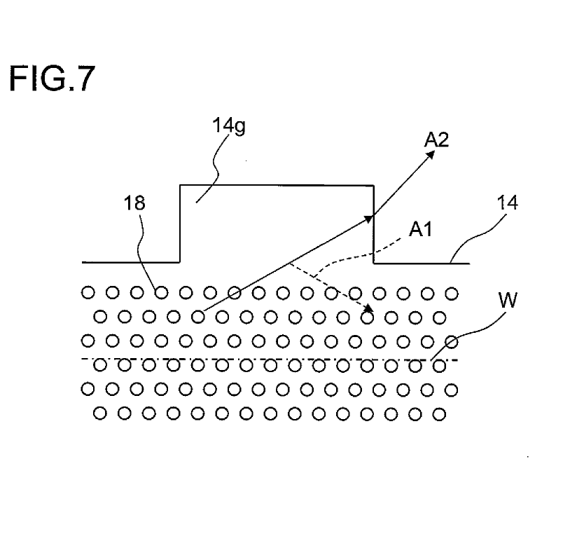

Furthermore, there is known an illumination device including a light guide plate that has, at a side circumferential surface thereof, a positioning portion provided in a projecting manner for the purpose of positioning and holding the light guide plate on a chassis. FIG. 7 is a plan view showing a vicinity of the positioning portion of this light guide plate. A positioning portion 14g is provided in a projecting manner at, for example, each of two orthogonal ones of side circumferential surfaces of a light guide plate 14 and is used for positioning of the light guide plate 14 by being fitted into an inner surface of a chassis (not shown).

Furthermore, a scattering pattern 18 in the form of dots provided on a back surface of the light guide plate 14 is provided to extend further to an outer circumference side beyond an emission region W for emitting illumination light so that uniform illumination light is emitted from the emission region W.

### LIST OF CITATIONS

### Patent Literature

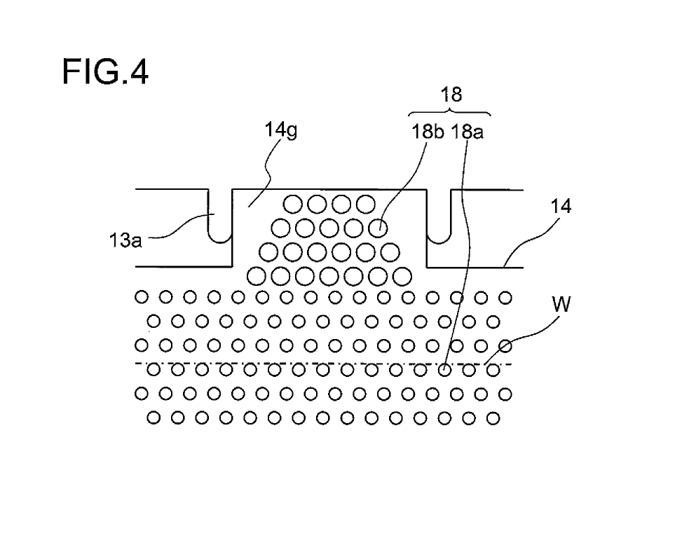

Patent Document 1: JP-A-2008-166200 (pages 4 to 5, FIG. 4)

Patent Document 2: JP-A-2011-142086 (pages 5 to 16, FIG. 11)

### SUMMARY OF THE INVENTION

### Technical Problem

According to the illumination device including the light guide plate 14 having the positioning portion 14g, however, light that, without the positioning portion 14g, would be totally reflected at the side circumferential surface of the light guide plate 14 as shown by an arrow Al is partly emitted via the positioning portion 14g as shown by an arrow A2. This has led to a problem that a luminance of illumination light in the emission region W is decreased in a vicinity of the positioning portion 14g, which results in the occurrence of luminance unevenness.

With regard thereto, providing a reflection sheet on an outer surface of the positioning portion 14g can prevent luminance unevenness. This, however, leads to a problem that the cost of the illumination device is increased, and a reflection characteristic of the reflection sheet is deteriorated over time, which results in the occurrence of luminance unevenness.

It is an object of the present invention to provide an illumination device that is capable of providing illumination light with a uniform luminance distribution, a display device using the same, and a television receiving device.

### Solution To the Problem

In order to achieve the above-described object, an illumination device according to the present invention includes a light source that is provided in side-by-side arrangement in one direction or provided to extend in one direction, a light guide plate that guides light that has entered from an incidence surface at a side circumferential surface thereof opposed to the light source and emits planar illumination light from an emission surface at a front surface thereof, a chassis that holds the light source and the light guide plate while covering a periphery of the light source and the light guide plate, a scattering pattern that is formed on a back surface of the light guide plate, and a positioning portion that is provided in a projecting manner at a side circumferential surface of the light guide plate and is used for positioning of the light guide plate by being fitted into an inner surface of the chassis. In the illumination device, the scattering pattern is provided to extend further onto the positioning portion.

According to this configuration, the positioning portion of the light guide plate is fitted into the inner surface of the chassis, and thus positioning of the light guide plate is achieved. Light emitted from the light source enters the light guide plate from the incidence surface and is guided therethrough to be reflected in a scattered manner by the scattering pattern provided at the back surface, so that planar illumination light is emitted from an emission region of the emission surface at the front surface. Furthermore, guided light that has reached the positioning portion is reflected in a scattered manner by a portion of the scattering pattern which is provided on the positioning portion, and is guided in a direction toward the emission region.

Furthermore, in the present invention, in the illumination device configured as above, a portion of the scattering pattern which lies on the positioning portion has density larger than density of a portion of the scattering pattern which lies on an emission region for emitting illumination light. According to this configuration, in the positioning portion, light reflected in a scattered manner in a direction toward the emission region is increased.

Furthermore, in the present invention, in the illumination device configured as above, the positioning portion is formed at an opposed surface opposed to the incidence surface and both surfaces contiguous to the incidence surface, and the positioning portions at the surfaces contiguous to the incidence surface are disposed at locations closer to the incidence surface than to the opposed surface.

Furthermore, in the present invention, in the illumination device configured as above, the scattering pattern is formed by printing.

Furthermore, in the present invention, in the illumination device configured as above, the scattering pattern is formed by using a white ink.

Furthermore, in the present invention, in the illumination device configured as above, the light source is a white light emitting diode.

Furthermore, in the present invention, in the illumination device configured as above, the white light emitting diode includes a light emitting chip that emits blue light and a luminous body layer that is provided around the light emitting chip and has an emission peak in a yellow region. According to this configuration, there is emitted white light resulting from mixing of blue light emitted by the light emitting chip and yellow light emitted by the luminous body layer.

Furthermore, in the present invention, in the illumination device configured as above, the white light emitting diode includes a light emitting chip that emits blue light and a luminous body layer that is provided around the light emitting chip and has an emission peak in each of a green region and a red region. According to this configuration, there is emitted white light resulting from mixing of blue light emitted by the light emitting chip and green light and red light emitted by the luminous body layer.

Furthermore, in the present invention, in the illumination device configured as above, the white light emitting diode includes a first light emitting chip that emits blue light, a luminous body layer that is provided around the first light emitting chip and has an emission peak in a green region, and a second light emitting chip that emits red light. According to this configuration, there is emitted white light resulting from mixing of blue light emitted by the first light emitting chip, green light emitted by the luminous boy layer, and red light emitted by the second light emitting chip.

Furthermore, in the present invention, in the illumination device configured as above, the white light emitting diode includes a first light emitting chip that emits blue light, a second light emitting chip that emits red light, and a third light emitting chip that emits green light. According to this configuration, there is emitted white light resulting from mixing of blue light emitted by the first light emitting chip, red light emitted by the second light emitting chip, and green light emitted by the third light emitting chip.

Furthermore, in the present invention, in the illumination device configured as above, the white light emitting diode includes a light emitting chip that emits ultraviolet light and a luminous body layer that is provided around the light emitting chip and has an emission peak in each of a blue region, a green region, and a red region. According to this configuration, there is emitted white light resulting from mixing of blue light, green light, and red light emitted by the luminous body layer.

Furthermore, a display device according to the present invention includes the illumination device configured as above and a display panel that is disposed so as to be opposed to the emission surface.

Furthermore, in the present invention, in the display device configured as above, the display panel is a liquid crystal panel using liquid crystal.

Furthermore, a television receiving device according to the present invention includes the display device configured as above.

### Advantageous Effects of the Invention

According to the present invention, the scattering pattern is provided to extend further onto the positioning portion provided in a projecting manner at the side circumferential surface of the light guide plate, and thus guided light that has reached the positioning portion is partly reflected in a scattered manner in a direction toward the emission region. With this configuration, light emitted sideways from the positioning portion is decreased, and thus decrease in luminance in the vicinity of the positioning portion is suppressed, so that illumination light with uniform luminance distribution can be provided.

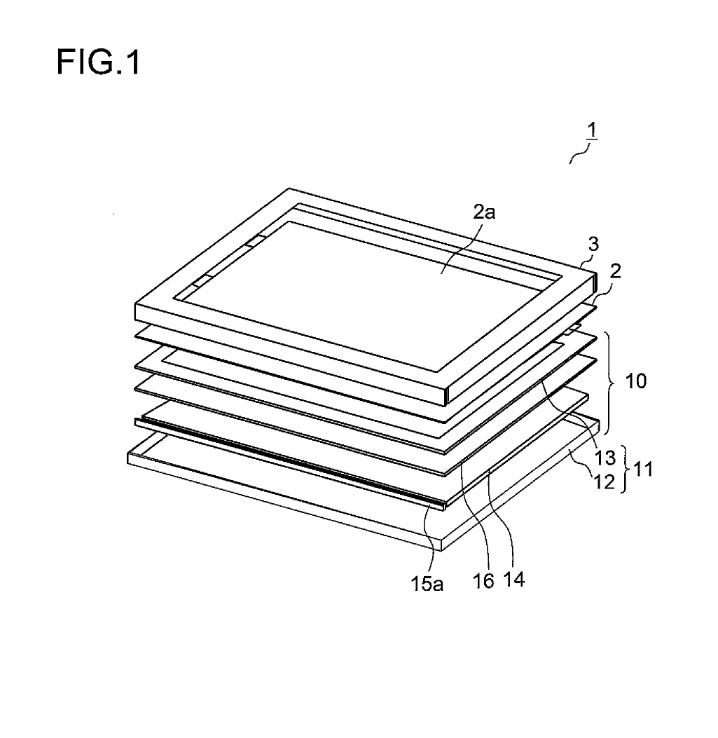

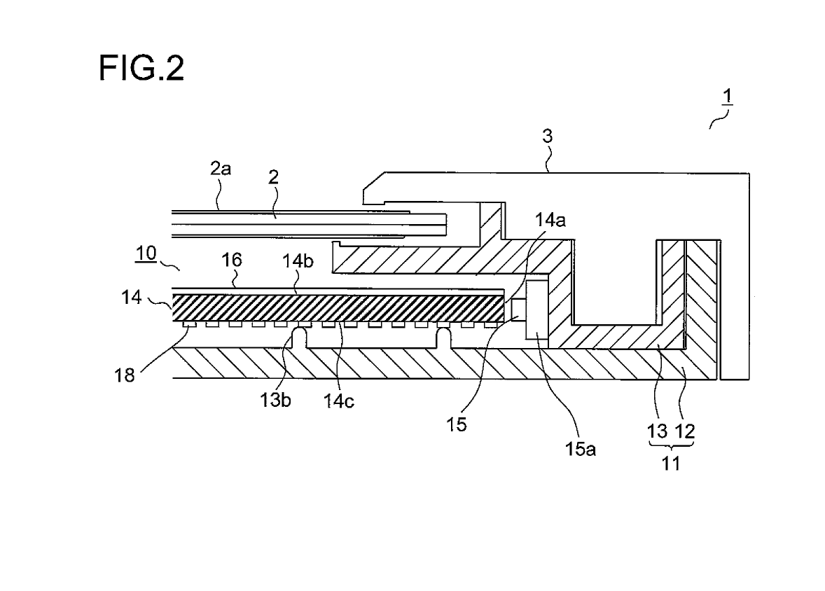

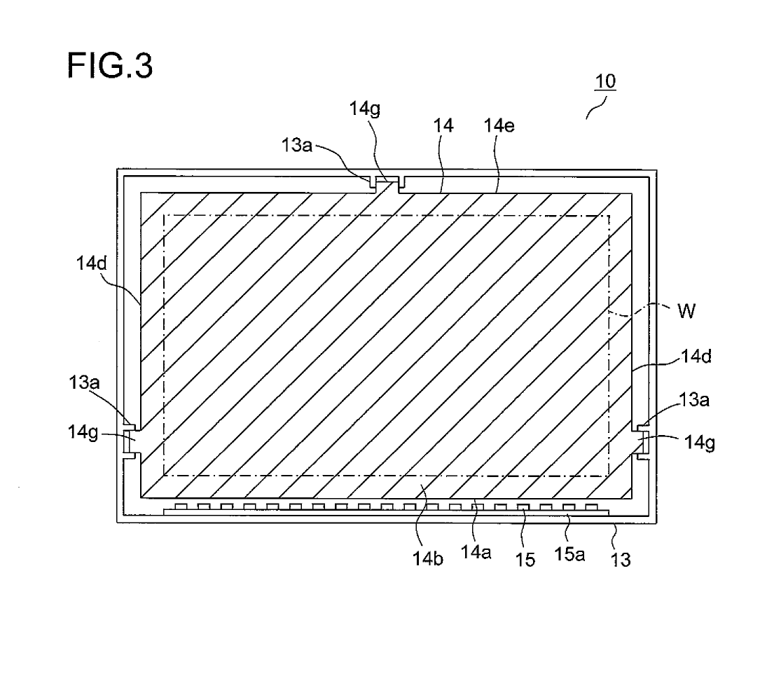

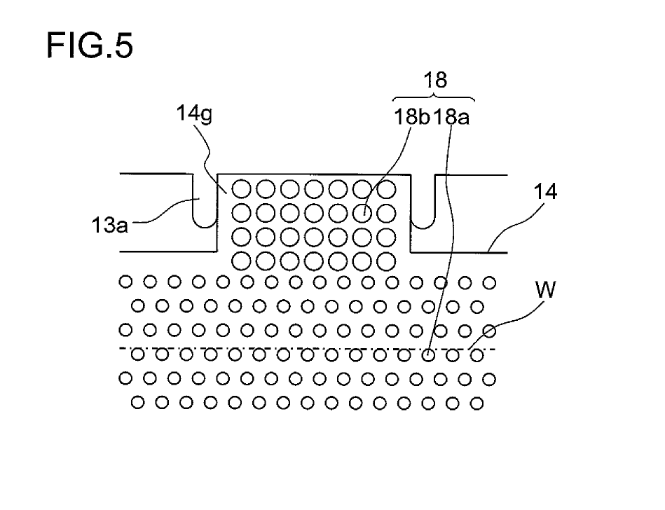

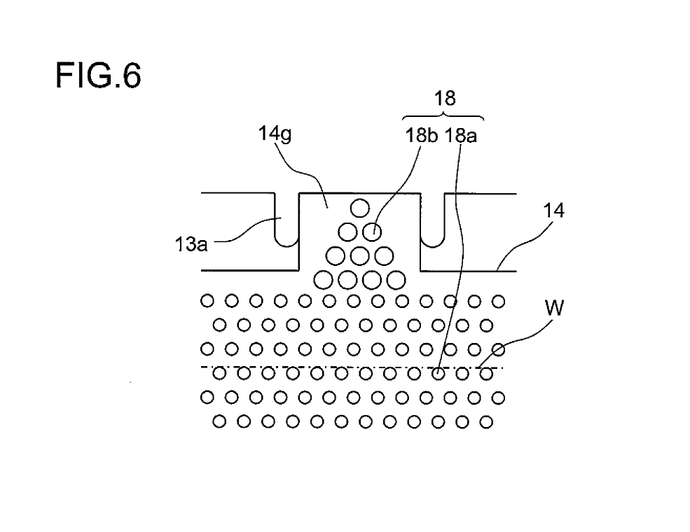

### BRIEF DESCRIPTION OF DRAWINGS

[FIG. 1] is an exploded perspective view showing a display device including an illumination device of a first embodiment of the present invention.

[FIG. 2] is a side sectional view showing the display device including the illumination device of the first embodiment of the present invention.

[FIG. 3] is a plan view showing the illumination device of the first embodiment of the present invention.

[FIG. 4] is a plan view showing a positioning portion of a light guide plate of the illumination device of the first embodiment of the present invention.

[FIG. 5] is a plan view showing a positioning portion of a light guide plate of an illumination device of a second embodiment of the present invention.

[FIG. 6] is a plan view showing a positioning portion of a light guide plate of an illumination device of a third embodiment of the present invention.

[FIG. 7] is a plan view showing a positioning portion of a light guide plate of a conventional illumination device.

### DESCRIPTION OF EMBODIMENTS

Hereinafter, embodiments of the present invention will be described with reference to the appended drawings. For the sake of convenience of explanation, in each of the drawings, portions similar to those in the foregoing conventional example shown in FIG. 7 are indicated by the same reference symbols. FIG. 1 is an exploded perspective view showing a display device including an illumination device of a first embodiment. A display device 1 is to be incorporated in a television receiving device or the like, and includes a liquid crystal panel 2 and an illumination device 10 that constitutes a backlight and is arranged behind the liquid crystal panel 2. The liquid crystal panel 2 is held to the illumination device 10 by a bezel 3 that covers a circumferential portion of a display surface 2a of the liquid crystal panel 2 at a front surface thereof.

The illumination device 10 is configured as an edge light type in which a light source 15 (see FIG. 2) is arranged so as to be opposed to an incidence surface 14a (see FIG. 2) at one side circumferential surface of a light guide plate 14 that is rectangular in planar view. The illumination device 10 is covered by a chassis 11 composed of a back portion 12 on a back surface side and a front portion 13 on a front surface side. Furthermore, on an emission surface 14b (see FIG. 2) of the light guide plate 14 at a front surface thereof, an optical sheet 16 such as a diffusion sheet is arranged.

FIG. 2 shows a side sectional view of the display device 1. The front portion 13 of the chassis 11 is made of a resin such as polycarbonate and covers a circumferential portion of the emission surface 14b of the light guide plate 14. A back surface of the liquid crystal panel 2 is supported by the front portion 13, and the liquid crystal panel 2 is held between the front portion 13 and the bezel 3.

The back portion 12 of the chassis 11 is made of a metal such as a steel plate, aluminum and the like or a resin such as polycarbonate, carbon fiber reinforced plastic (CFRP) and the like. The use of a resin to form the back portion 12 can achieve a weight reduction and thus is more preferable. The back portion 12 has a plurality of ribs 13b that are provided in a projecting manner to extend in a direction parallel to the incidence surface 14a of the light guide plate 14 and support a back surface 14c of the light guide plate 14. With this configuration, the ribs 13b make line contact with the light guide plate 14. The ribs 13b may be provided to extend in a direction orthogonal to the incidence surface 14a or may be formed so as to make point contact with the light guide plate 14.

The light guide plate 14 is formed of a thin plate rectangular in planar view, which is made of a transparent member such as acrylic, and guides light that has entered from the incidence surface 14a. A scattering pattern 18 for reflecting light in a scattered manner is provided on the back surface 14c of the light guide plate 14. The light source 15 is formed of a white light emitting diode mounted on a substrate 15a, and a plurality of the light sources 15 are provided side by side in one direction along the incidence surface 14a of the light guide plate 14 at the one side circumferential surface thereof. The light source 15 may be formed in a linear shape and provided to extend in one direction along the incidence surface 14a.

The white light emitting diode forming the light source 15 has, for example, a light emitting chip that emits blue light and a luminous body layer that is provided around the light emitting chip and has an emission peak in a yellow region. With this configuration, there is emitted white light resulting from mixing of blue light emitted by the light emitting chip and yellow light emitted by the luminous body layer. The luminous body layer can be formed by containing a phosphor that performs wavelength conversion of blue light of the light emitting chip into yellow light.

Here, the white light emitting diode may have a light emitting chip that emits blue light and a luminous body layer that is provided around the light emitting chip and has an emission peak in each of a green region and a red region. With this configuration, there is emitted white light resulting from mixing of blue light emitted by the light emitting chip and green light and red light emitted by the luminous body layer. The luminous body layer can be formed by containing phosphors that perform wavelength conversion of blue light of the light emitting chip into green light and red light, respectively.

Also, the white light emitting diode may have a first light emitting chip that emits blue light, a luminous body layer that is provided around the first light emitting chip and has an emission peak in a green region, and a second light emitting chip that emits red light. With this configuration, there is emitted white light resulting from mixing of blue light emitted by the first light emitting chip, green light emitted by the luminous body layer, and red light emitted by the second light emitting chip. The luminous body layer can be formed by containing a phosphor that performs wavelength conversion of blue light of the first light emitting chip into green light.

Furthermore, the white light emitting diode may have a first light emitting chip that emits blue light, a second light emitting chip that emits red light, and a third light emitting chip that emits green light. With this configuration, there is emitted white light resulting from mixing of blue light emitted by the first light emitting chip, red light emitted by the second light emitting chip, and green light emitted by the third light emitting chip.

Furthermore, the white light emitting diode may have a light emitting chip that emits ultraviolet light and a luminous body layer that is provided around the light emitting chip and has an emission peak in each of a blue region, a green region, and a red region. With this configuration, there is emitted white light resulting from mixing of blue light, green light, and red light emitted by the luminous body layer. The luminous body layer can be formed by containing phosphors that perform wavelength conversion of ultraviolet light of the light emitting chip into blue light, green light, and red light, respectively.

FIG. 3 shows a plan view of the illumination device 10. The light guide plate 14 which is arranged on an inner side of the front portion 13 of the chassis 11 has a positioning portion 14g that is provided in a projecting manner at each of an opposed surface 14e opposed to the incidence surface 14a and both side surfaces 14d contiguous to the incidence surface 14a. The positioning portions 14g at both the side surfaces 14d are disposed at locations closer to the incidence surface 14a than to the opposed surface 14e.

On an inner circumferential surface of the front portion 13, a plurality of ribs 13a into each of which the positioning portion 14g is to be fitted are provided in a projecting manner. The positioning portion 14g is fitted into each of the ribs 13a, and thus the light guide plate 14 is held in a state where positioning thereof is achieved in directions parallel to and perpendicular to the incidence surface 14a, respectively. A concave portion into which the positioning portion 14g is to be fitted may be provided by forming a concave on the inner circumferential surface of the front portion 13.

Since the circumferential portion of the emission surface 14a of the light guide plate 14 is covered by the front portion 13 (see FIG. 2), the emission region W for emitting illumination light is formed on a side inward of an outer circumference. The liquid crystal panel 2 (see FIG. 1) is illuminated with illumination light emitted from the emission region W.

FIG. 4 is a plan view showing a detail of the positioning portion 14g of the light guide plate 14. The scattering pattern 18 formed on the back surface 14c (see FIG. 2) of the light guide plate 14 is formed in the form of, for example, white dots that are circular in planar view, and a multitude of such dots are disposed so as to be dispersed in a triangular lattice shape. The scattering pattern 18 may be disposed in a tetragonal lattice shape or in a random manner. The scattering pattern 18 can be formed by, for example, printing, by screen printing, ink-jet printing, or the like, a white ink in paste form containing a metal oxide on the back surface 14c of the light guide plate 14.

The scattering pattern 18 is not only provided in the emission region W but also provided to extend further to an outer circumference side beyond the emission region W and even further onto the positioning portion 14g. A scattering pattern 18b lying on the positioning portion 14g is disposed in a trapezoidal shape in planar view. In this case, the scattering pattern 18b lying on the positioning portion 14g is formed to have a dot diameter larger than that of a scattering pattern 18a lying on the emission region W. As a result, the scattering pattern 18b lying on the positioning portion 14g has density larger than density of the scattering pattern 18a lying on the emission region W.

In the display device 1 configured as above, light emitted from the light source 15 enters the light guide plate 14 from the incidence surface 14a and is guided through the light guide plate 14. Guided light that has reached the back surface 14c of the light guide plate 14 is reflected in a scattered manner by the scattering pattern 18. With this configuration, light that enters the emission surface 14b at an incidence angle smaller than a critical angle is generated, so that planar illumination light is emitted from the emission region W of the emission surface 14b. The liquid crystal panel 2 is illuminated with the illumination light emitted from the emission region W, and thus an image is displayed on the display surface 2a.

Furthermore, since the scattering pattern 18 is provided to extend further to the outer circumference side beyond the emission region W, illumination light can be emitted such that it is uniform even at a circumferential edge of the emission region W. Moreover, since the scattering pattern 18b is provided on the positioning portion 14g, light that has been guided through the light guide plate 14 and reached the positioning portion 14g is reflected in a scattered manner by the scattering pattern 18b. With this configuration, reflection light reflected by the scattering pattern 18b is partly guided in a direction toward the emission region W, and thus light emitted sideways from the positioning portion 14g is decreased.

According to this embodiment, the scattering pattern 18 is provided to extend further onto the positioning portion 14g provided in a projecting manner at the side circumferential surface of the light guide plate 14, and thus guided light that has reached the positioning portion 14g is partly reflected in a scattered manner in the direction toward the emission region W. With this configuration, light emitted sideways from the positioning portion 14g is decreased, and thus decrease in luminance in the vicinity of the positioning portion 14g is suppressed, so that illumination light with a uniform luminance distribution can be provided.

Furthermore, since the scattering pattern 18b lying on the positioning portion 14g has density larger than density of the scattering pattern 18a lying on the emission region W, in the positioning portion 14g, light reflected in a scattered manner in direction toward the emission region W can be increased. Thus, illumination light with a further uniform luminance distribution can be provided.

Furthermore, the positioning portions 14g at both the side surfaces 14d contiguous to the incidence surface 14a are disposed at locations closer to the incidence surface 14a than to the opposed surface 14e. With this configuration, the light guide plate 14 can be further stably supported. In this case, it becomes easy for emission light emitted by those ones of the light sources 15 which are located at both end portions of the incidence surface 14a to reach the positioning portions 14g at both the side surfaces 14d disposed at locations close to the ones of the light sources 15. Accordingly, with the scattering pattern 18 provided to extend further onto the positioning portion 14g, effect of decreasing light emitted sideways from the positioning portion 14g is enhanced.

Furthermore, the scattering pattern 18 can be easily formed by printing a white ink.

Furthermore, since the light source 15 is a white light emitting diode, the illumination device 10 constituting a backlight can be easily realized.

Next, FIG. 5 is a plan view showing a positioning portion 14g of a light guide plate 14 of an illumination device 10 of a second embodiment. For the sake of convenience of explanation, portions similar to those in the foregoing first embodiment shown in FIGS. 1 to 4 are indicated by the same reference symbols. This embodiment is different from the first embodiment in how a scattering pattern 18b lying on the positioning portion 14g is disposed. Other portions are similar to those in the first embodiment.

A scattering pattern 18 is provided to extend further onto the positioning portion 14g, and the scattering pattern 18b lying on the positioning portion 14g is disposed in a rectangular shape in planar view. In this case, the scattering pattern 18b lying on the positioning portion 14g is formed to have a dot diameter larger than that of a scattering pattern 18a lying on an emission region W. With this configuration, effects similar to those of the first embodiment can be obtained.

Next, FIG. 6 is a plan view showing a positioning portion 14g of a light guide plate 14 of an illumination device 10 of a third embodiment. For the sake of convenience of explanation, portions similar to those in the foregoing first embodiment shown in FIGS. 1 to 4 are indicated by the same reference symbols. This embodiment is different from the first embodiment in how a scattering pattern 18b lying on the positioning portion 14g is disposed. Other portions are similar to those in the first embodiment.

A scattering pattern 18 is provided to extend further onto the positioning portion 14g, and the scattering pattern 18b lying on the positioning portion 14g is disposed in a triangular shape in planar view. In this case, the scattering pattern 18b lying on the positioning portion 14g is formed to have a dot diameter larger than that of a scattering pattern 18a lying on an emission region W. With this configuration, effects similar to those of the first embodiment can be obtained.

While in each of the first to third embodiments, the illumination device 10 is formed as a one-side light incidence type in which the light sources 15 are arranged along only one side of the light guide plate 14, a two-side light incidence type also may be adopted in which the light sources 15 are arranged along opposed two sides of the light guide plate 14.

### INDUSTRIAL APPLICABILITY

The present invention is applicable to display devices using an illumination device having a light guide plate, such as of a television receiving device, a display, and a mobile phone.

### LIST OF REFERENCE SYMBOLS

1 liquid crystal display device

2 display panel

3 bezel

10 illumination device

11 chassis

12 back portion

13 front portion

13a rib

14 light guide plate

14a incidence surface

14b emission surface

14c back surface

14g positioning portion

15 light source

16 optical sheet

18, 18a, 18b scattering pattern

1. An illumination device comprising:
a light source that is provided in side-by-side arrangement in one direction or provided to extend in one direction;
a light guide plate that guides light that has entered from an incidence surface at a side circumferential surface thereof opposed to the light source and emits planar illumination light from an emission surface at a front surface thereof;
a chassis that holds the light source and the light guide plate while covering a periphery of the light source and the light guide plate;
a scattering pattern that is formed on a back surface of the light guide plate; and
a positioning portion that is provided in a projecting manner at a side circumferential surface of the light guide plate and is used for positioning of the light guide plate by being fitted into an inner surface of the chassis,
wherein
the scattering pattern is provided to extend further onto the positioning portion.

2. The illumination device according to claim 1, wherein
a portion of the scattering pattern which lies on the positioning portion has density larger than density of a portion of the scattering pattern which lies on an emission region for emitting illumination light.

3. The illumination device according to claim 1, wherein
the positioning portion is formed at an opposed surface opposed to the incidence surface and both surfaces contiguous to the incidence surface, and
the positioning portions at the surfaces contiguous to the incidence surface are disposed at locations closer to the incidence surface than to the opposed surface.

4. The illumination device according to claim 1, wherein
the scattering pattern is formed by printing.

5. The illumination device according to claim 1, wherein
the scattering pattern is formed by using a white ink.

6. The illumination device according to claim 1, wherein
the light source is a white light emitting diode.

7. The illumination device according to claim 6, wherein
the white light emitting diode includes a light emitting chip that emits blue light and a luminous body layer that is provided around the light emitting chip and has an emission peak in a yellow region.

8. The illumination device according to claim 6, wherein
the white light emitting diode includes a light emitting chip that emits blue light and a luminous body layer that is provided around the light emitting chip and has an emission peak in each of a green region and a red region.

9. The illumination device according to claim 6, wherein
the white light emitting diode includes a first light emitting chip that emits blue light, a luminous body layer that is provided around the first light emitting chip and has an emission peak in a green region, and a second light emitting chip that emits red light.

10. The illumination device according to claim 6, wherein
the white light emitting diode includes a first light emitting chip that emits blue light, a second light emitting chip that emits red light, and a third light emitting chip that emits green light.

11. The illumination device according to claim 6, wherein
the white light emitting diode includes a light emitting chip that emits ultraviolet light and a luminous body layer that is provided around the light emitting chip and has an emission peak in each of a blue region, a green region, and a red region.

12. A display device, comprising:
the illumination device according to claim 1; and
a display panel that is disposed so as to be opposed to the emission surface.

13. The display device according to claim 12, wherein
the display panel is a liquid crystal panel using liquid crystal.

14. A television receiving device comprising the display device according to claim 12.
